(19) United States
(12) Patent Application Publication
(10) Pub. No.: US 2005/0254718 A1
(43) Pub. Date: Nov. 17, 2005

(54) Web-oriented image database building/control method

(76) Inventor: Ryozo Setoguchi, Tokyo (JP)

Correspondence Address: H. Henry Koda;KODA & ANDROLLA, 2029 Century Park East, Suite 1430, Los Angeles, CA, 90067-3024, US

(21) Appl. No.: 10/506,569

(22) PCT Filed: Mar. 4, 2002
(86) PCT No.: PCT/JP02/01953

§ 371 Date: Sep. 2, 2004

(51) Int. Cl. G06K 9/36

(52) U.S. Cl. 382/240

(57) ABSTRACT

Enlarged image display by Jpeg is possible by a browser, compared to the Jpeg image processing. It is, however, difficult for the user to actually create an image of a scale desired by the user even if the image is visually large, since the scale is fixed. If such a request is made, it is necessary to create an image of each required scale. It is possible to view a large image because the scale of image can be varied by the wavelet conversion based on extension mapping proposed here. It is, here, easy for the user to create an image of a scale desired by the user. The image of each scale does not need to be created; and since an image of an arbitrary scale can be created from one image, an image of extension mapping can be readily created in response to the user's request. With an image processing mechanism having such a function, a unique, novel dynamic image database can readily and freely be built. The system mechanism therein is also a system that has evolved in the form not expected by conventional methods.

### TECHNICAL FIELD

The present invention relates to a supplemental technology for smoothly realizing storage, retrieval and processing of picture image information, etc. in a predetermined information processing equipment such as a computer. This technology includes the technology which is comfortably and freely conjugated under the Internet environment and high-speed information communication environment such as broadband.

The basic technology of the present invention is a technology that expands a picture image without degrading the quality of the image. As an accompanying technology that creates a clear detailed image from an image of low resolution and low quality without degrading the quality of the picture image, web environments and so on are realized; and since a required image size and picture quality can be created from a base picture image, a picture image database that is low cost and has efficiency can be constructed. A high-efficient and high performance data management of the image datum in the web environment, etc. can be expected.

### BACKGROUND ART

Recently, a phrase “broad band” is widely used. Though this has the meaning of “wide band,” it is a terminology that means high speed and large traffic in the communication environment in the information terminology. Clearly, today's web environment may be regarded here that it rapidly evolves during several years. Here, a great amount of media data such as video image and picture image becomes transmittable on the web.

However, on the other hand, a tendency has appeared that the number of new users and corporations who contract providers rapidly increases due to the convenience of the web environment caused by speeding up in communications, etc.; and moreover, the number of web users shows great increases. In addition, due to the improvement in the rapid processing performance of computers and capacity enlargement of memory systems, opportunities that handle media data which is larger than the past in quantities has increased, and a system that is uniformly controlled has been strongly demanded.

One of the important technologies which can deal with a demand of such a web utilization environment and users (collectively called “user” hereinafter) is a picture image database system. This is a technology in which users are able to retrieve and display picture images in compliance with usage conditions on the web, and it becomes possible for users to read large picture image information through the computer.

However, it is not useful to merely accumulate large picture image in database. In order to more effectively utilize the database, a simplicity in the operation by users, a work reduction on managers, picture image capacities on the server side, a reduction in the object number, etc. are required.

It is more effective to use separately a function concentrated type database system (a server accompanied by a function of picture image operation) and a function disperse type database system (a client accompanied by a function of picture image operation). Accordingly, it is also necessary to consider the construction of such database systems that have such functions.

At present, image database system which is currently used generally (called a “static database system” hereinafter) functions so as to display only some picture image which the server side has prepared beforehand on the web browser. However, database proposed here is a database system (called a “dynamic data based system” hereinafter) in which a picture image is shown in an extended manner.

Therefore, the present invention provides a web picture image database system, in which a picture image of desired size which the user requires from one picture image can be produced not only by picture image processing on the server side but also by the client side.

The present invention propose, as such a web picture image database system, a proper approach which realizes a new database system that executes an extension display operable directly and automatically, in addition of form and quality of media data type picture image.

### DISCLOSURE OF INVENTION

The present invention relates to a technology, which depends on the method of picture image extension that can be defined as an “extension mapping” which is a novel and unique method on wavelet transform as the basic technology of a core of the present invention, and this is called a “wavelet extension mapping.”

The wavelet transform is a method that includes analytic and synthesizing process of a picture image. The analytic process is called a reduction process, which means an operation of frequency development of a picture image, and the synthesizing processes is called a restoration process, which means a regeneration operation of a picture image. The wavelet extension mapping is a method that expands and reproduces a picture image, in which a picture image structure specified in the reduction process is preserved in the extension operation of picture image as well, as in a synthesizing operation of picture image.

A specified picture image structure in this conversion operation is shown in FIG. 1. The picture image structure shown here corresponds to a frequency distribution of a picture image. L in this figure corresponds to a low frequency region of the frequency component on the picture image luminance, and H corresponds to a high frequency range. The region L is further decomposed, depending upon the decomposition level, into regions of LL, LLL. For example, in the decomposition level (2), regions LH and HL, in which the reduction/resolution process is an intermediate frequency, are generated. An example of actual picture image decomposition to which the decomposition level (2) corresponds is shown in FIG. 2.

Apparently, since the region L clearly corresponds to the outline of the shape of an object picture image, the decomposition process can be called a compression process, and the synthesizing process can be called restoration process; however, the region L is mostly not compressed. In the region H, etc., a two-dimensional high frequency component is preserved.

In respect to the actual reduction process, a concrete picture image resolution is shown in FIG. 2.

The wavelet transform is a conversion on the frequency domain; and by applying this to a picture image structure, a picture image processing such as resolution (compression) and synthesis (decompression) conversions, etc. are executed. Here, a structure of saving, which naturally depends on frequency development based on the decomposition operation, is considered as a picture image structure for conversion.

As described above, the wavelet transform is a method developed, usually as well as Fourier transformation, with a purpose of picture image quality management such as picture image enhancement and picture image adjustment; and it is a conversion related to the frequency domain.

The wavelet transform is not positively used as an operation of compression and restoration. The reason for this is considered that its compression is not as sufficient as expected.

In the wavelet extension mapping, an operation of picture image extension is realized, based upon picture image structure, as a recursive structure. In the wavelet transform, with algorithm that recursively uses resolution, a picture image extension is executed.

In the fractal operation, a picture image extension by the recursive structure is called a fractal extension mapping. Following the picture image extension in the fractal transformation, the picture image extension by the recursive structure is called a wavelet extension mapping.

The fractal extension mapping is a method for carrying out extension and reduction by a geometric similarity law of the shape. The operation of this kind is used in the technology of encryption executed by compression and restoration.

Fractal compression in the picture image processing is an operation that is based on reduction mapping. The reduction mapping is a kind of geometric conversion based on affine transformation; and the affine transformation is a geometric operation that depends upon, in addition to rotation and parallel translation, a deformation operation and an extension and reduction of a shape.

The fractal extension is an inverse transform of the reduction mapping. Like the restoration process, it is a conversion operation by the information structure of the reduction mapping. What makes the fractal transformation differs from the wavelet transform is that though the wavelet transform is a conversion on the frequency that corresponds to a picture image luminance, the fractal transformation means a geometric conversion on an object shape.

Though the content of conversion is different, their fundamental structures are similar to each other; and a concept in which a picture image structure that is specified in the conversion is preserved is used. By way of positively recognizing the algorithmic structure that preserves the property in such an inverse transform, the extension mapping is sufficiently expected in the wavelet transform.

The wavelet extension mapping can be realized as a process of obtaining an extended picture image of an original picture image, if the restoration process, which is an inverse transform that takes the original picture image as operation object picture image/synthesizing and regeneration picture image in the extension operation, is recursively executed.

A picture image, which is expanded four times larger than the original picture image by the process of actual wavelet extension mapping, is shown in FIG. 3.

Using the above mechanism of image extension as a core, a mechanism in which a picture image processing caused by wavelet transform is incorporated can be established. With this incorporated mechanism, a unitary picture image processing becomes possible, and, therefore, this is called an integrated wavelet type picture image processing mechanism.

Taking the integrated wavelet type picture image processing mechanism as a core, a novel and unique database can be constructed. Here, the integrated wavelet type picture image processing mechanism is provided as a support system of DBMS (Data Base Management System). In addition, a picture image of the low frequency component obtained by resolution process of the wavelet transform is used for the thumbnail as picture image database. Simultaneously, information on the frequency obtained by picture image information of resolution process is chiefly stored in the picture image database. As a retrieval function of the picture image database, a relational database is prepared as a metafile.

On the other hand, a server concentrated dynamic picture image database system can be constructed as a good flexibility and efficiency system in the web environment. In addition, a client distributed dynamic picture image database can be constructed as a system in which a flexible efficiency is good.

In the server concentrated dynamic picture image database system, the integrated wavelet type picture image processing mechanism is provided as a core of the server browser. Likewise, the integrated wavelet type picture image processing mechanism is provided in the client distributed dynamic picture image database as a core of the client browser. As a result, picture image database in which a retrieval precision is high unlike conventional image database is expected. At the same time, a WWW (World Wide Web) system that has a high utilization level, which involves, as its core, a dynamic picture image database of shapes and which suits the web environment, can be constructed.

### BRIEF DESCRIPTION OF DRAWINGS

FIG. 1 shows a picture image structure obtained, as a resolution process, by the wavelet transform.

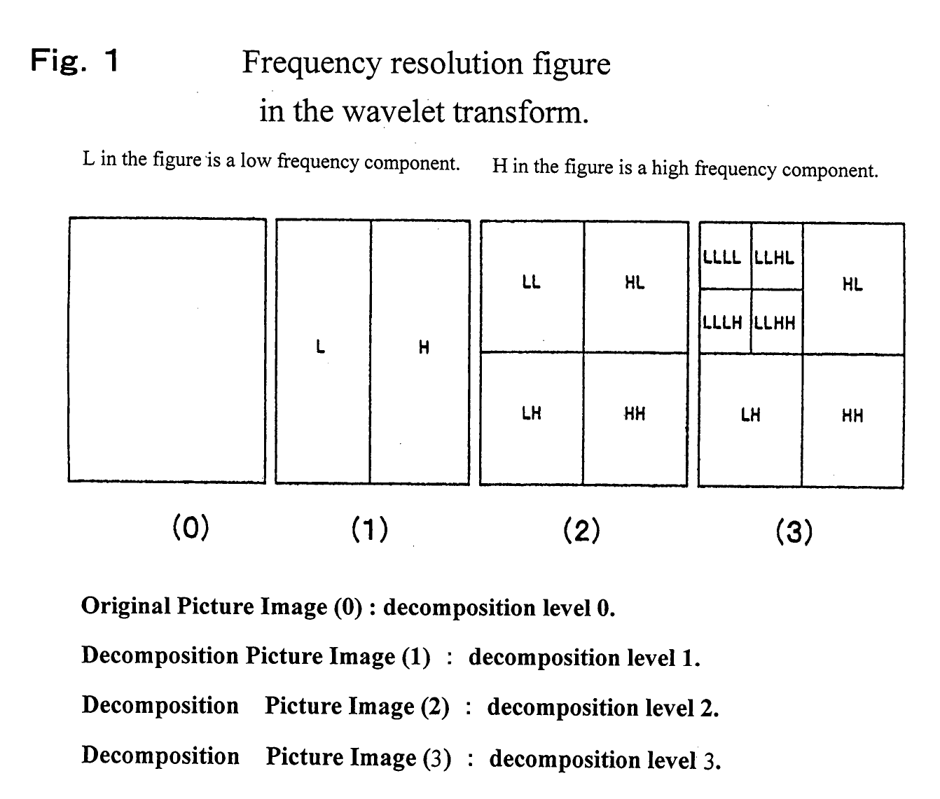

FIG. 2 shows actual concrete picture image resolution in the reduction process by wavelet transform.

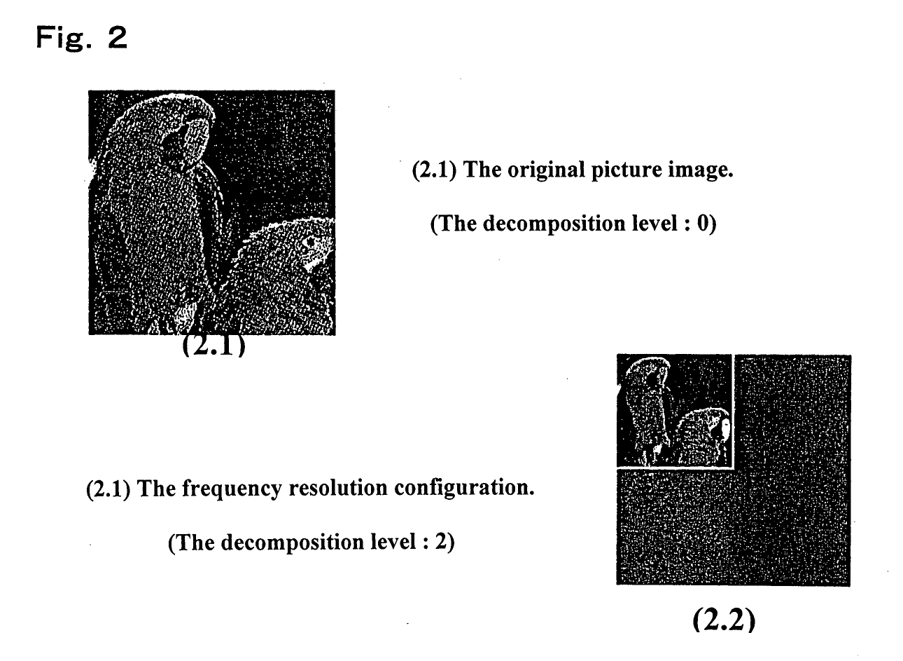

FIG. 3 shows a four-time extended picture image of the original picture image which is done by the actual wavelet extension mapping process.

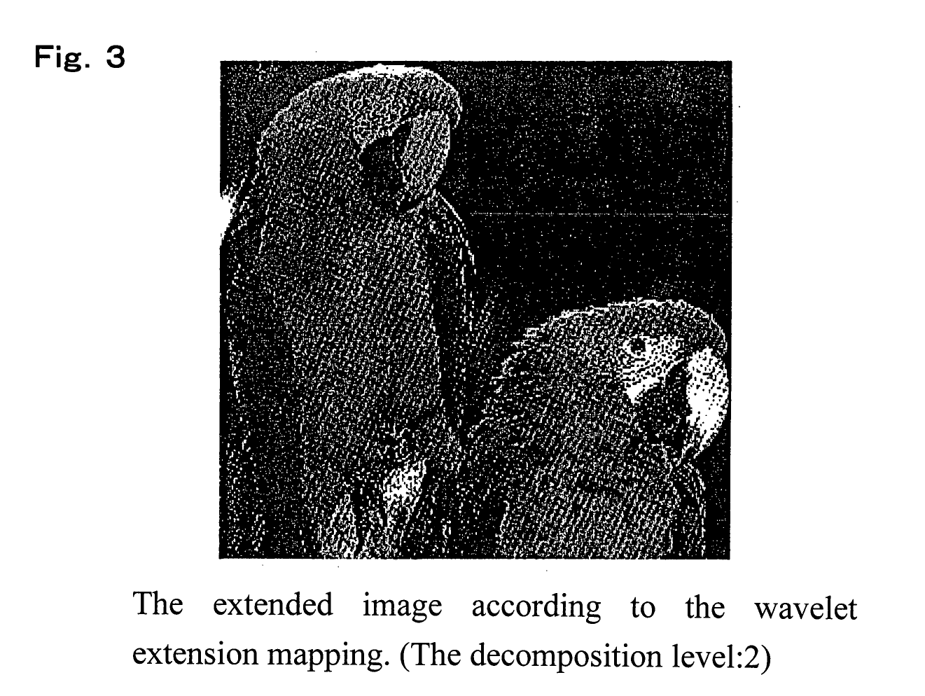

FIG. 4 shows the mechanism of a server concentrated dynamic web picture image database.

FIG. 5 shows the mechanism of a client distributed dynamic web picture image database.

FIG. 6 shows a configuration of the server concentrated dynamic web database system.

FIG. 7 is a state transition diagram of the server concentrated dynamic web database system.

FIG. 8 is a configuration of the client distributed dynamic web database system.

FIG. 9 is a state transition diagram of the client distributed dynamic web database system.

FIG. 10 shows the hierarchical structure in a wavelet system that is a core in the integrated picture image processing mechanism.

FIG. 11 shows the recursive procedure and example of procedure in the integrated picture image processing method.

### BEST MODE FOR CARRYING OUT THE INVENTION

Here, two systems will be described as examples.

One of the examples is a server concentrated dynamic picture image database system, and another one of the examples is a client distributed picture image database system.

The fundamental structure of the server concentrated dynamic web picture image database system is the same as the structure of the static web picture image database system currently used, and therefore, the function of the server concentrated dynamic web picture image database system is divided into a server side and a client side. In this situation, a CGI environment, which is comprised of web database and a picture image processing function on the server side and a web browser on the client side, is constructed.

In this case, it becomes possible that a user issues a request and acquires information and picture image which coincide with the information of a retrieval key. Moreover, in the static web picture image database system, when a requested picture image which coincides with the retrieval information is small and a strain exists in the picture image, a situation in which a given information cannot be correctly recognized by the user would occur.

However, in the server concentrated dynamic web picture image database system, by way of building therein an integrated picture image processing mechanism which positively utilizes CGI of the server side, a picture image of multiple extension mapping can be composed by one sheet of displaying picture image that corresponds to the retrieval information; accordingly, it is possible to realize a required picture image by adjusting to the magnification which the user requested. In addition, by way of introducing the dynamic web image database system, it is possible to form a system that can satisfy a seller who needs to correctly transmit information to a user who requests a display of repaired spots of scratches, dents, etc. for a used car retrieval site and to a user who requests visual information of, for instance, a layout and direction and the condition of the interior finishing for a residential information site.

For a server manager, it is not necessary to create a newly extended picture image in addition to an image that is created and displayed for users and sellers, and only the necessity is to upload beforehand only one sheet of original picture in the display of the server side. Therefore, management becomes very easy for a server manager of the retrieval site. Also, it becomes possible to give immediacy in the retrieval site, because a user does not need to request an extended picture image to the manager.

Furthermore, on the server side in the dynamic web picture image database system, increase in the individual picture image information, in addition to a large-scale increase in the number of objects that is seen in the static web picture image database system, can be eliminated. It is also possible to eliminate such a secondary obstacle as performance degradation that is caused by memory shortage in the database server. In addition, since the manager of the server is able to avoid claims of users as much as possible, users and sellers that use such a retrieval site can expect improvement in the service, and as a result, the user number increase can be naturally expected.

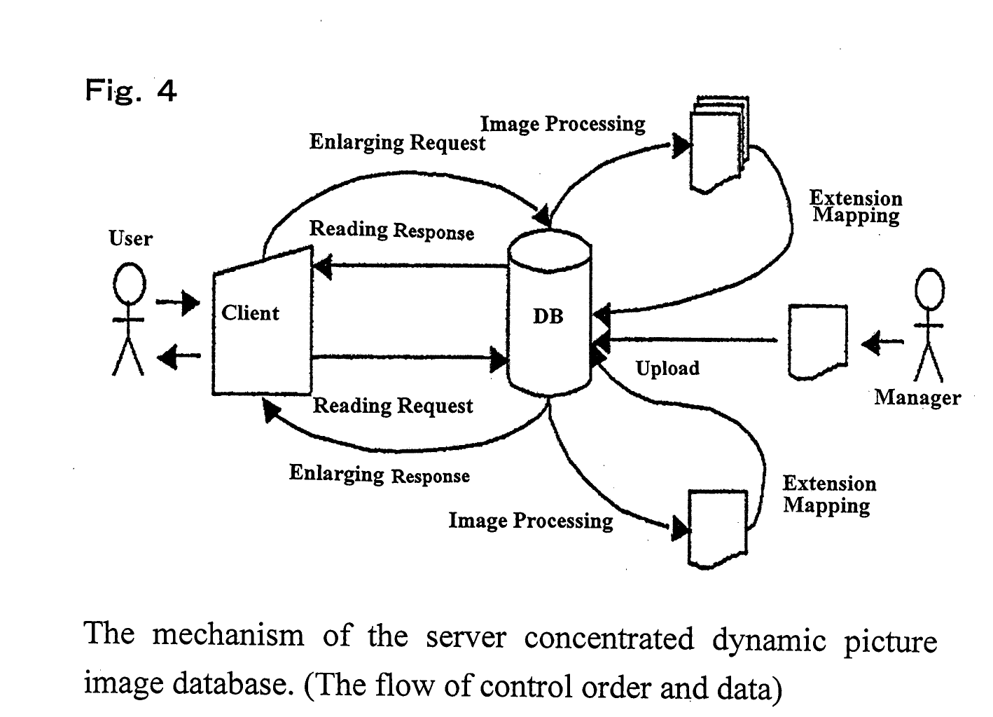

In FIG. 4, a series of this action is schematically shown from the viewpoint of user and server manager, and the procedure will be described.

The flow of the operating procedure in this case is shown below. More specifically,
\mathring{1} A manager uploads a compressed picture image so as to create a picture image database system and to start the service.
\mathring{2} In the web site implemented the web picture image database system therein, a user issues a reading request of the database system through web browser.
\mathring{3} The picture image database system, which received the reading request from the client, analyzes the reading request. The result is reported in the form of a response for reading (response) to the client.
\mathring{4} The client receives the response for reading which the picture image database system issued, and it is offered in the form of display of picture image information to the user.
\mathring{5} If the user is satisfied with the received picture image information, the process ends at this point. However, if the picture image information is imperfect and unrecognizable for the user, then the user issues an enlarging (extension) request to the server.
\mathring{6} When the enlarging request from the user is received, the picture image database system executes picture image processing immediately and performs extension mapping to the size that meets the user's request from the client.
\mathring{7} In order to provide a picture image of extension mapping, the picture image database system carries out a response for extension through the web for the client.
\mathring{8} The user reads the extension mapping via the client.

However, the fundamental structure of the client distributed dynamic web picture image database system differs from the structures of the static web picture image database system used conventionally and of the server concentrated dynamic web picture image database system presented here; and functions of picture image processing, etc. are dispersedly provided in each of the client side and server side. Here, a CGI environment, which possesses the web database capability, is established in the server side, when the client application of a web browser for request and a combined picture image response and picture image processing are embedded in the client side.

In other words, a user issues a request; and as a result, it becomes possible that information and picture image, which coincide with the retrieval key, are acquired.

As described above, in the static web picture image database system, a given information cannot be accurately recognized by the user when there is a strain in the picture image and when a picture image that coincides with retrieval information is small.

On the other hand, in the server concentrated dynamic web picture image database system, the picture image of multiple extension mapping which coincides with the magnification which the user requests from the displaying picture image that is given as a result of retrieval can be acquired by building in the integrated picture image processing mechanism using CGI of the server side. Clearly, use of the server concentrated dynamic web picture image database system in the large-scale network environment is not adequate, because image processing, etc. is carried out for each access to every picture based on the integrated picture image treatment mechanism on the server side.

Therefore, if the integrated picture image treatment mechanism is dispersed to clients, and image processing, etc. is executed, then the information processing quantity in the server can be reduced.

Like in the server concentrated dynamic web picture image database system, if the retrieval site server manager retains, in addition to the picture image being displayed for users and sellers, only one sheet of original picture beforehand as a retrieval and display picture image on the server side and uploads this original picture without newly making extended picture image, then it is possible to deal with all the demands; and as a result, the management of database becomes easy. In addition, it becomes possible for the retrieval site to have an instancy, because the user does not need to request the manager for an extended picture image.

In other words, in the server side and client side of the dynamic web picture image database system, response methods and efficiency to the client, etc. can be decided by way of taking account the appropriate processing quantity in each site so that the system can meet the LAN and exclusive lines, the line speeds in dial up, the number of terminals and the number of people who make an access.

As seen from the above, the system is able to work effectively under various network environments, if a service that corresponds to the network environment is offered; and reuse of information becomes possible in order to conjugate as very useful information when, for instance, a system is newly constructed.

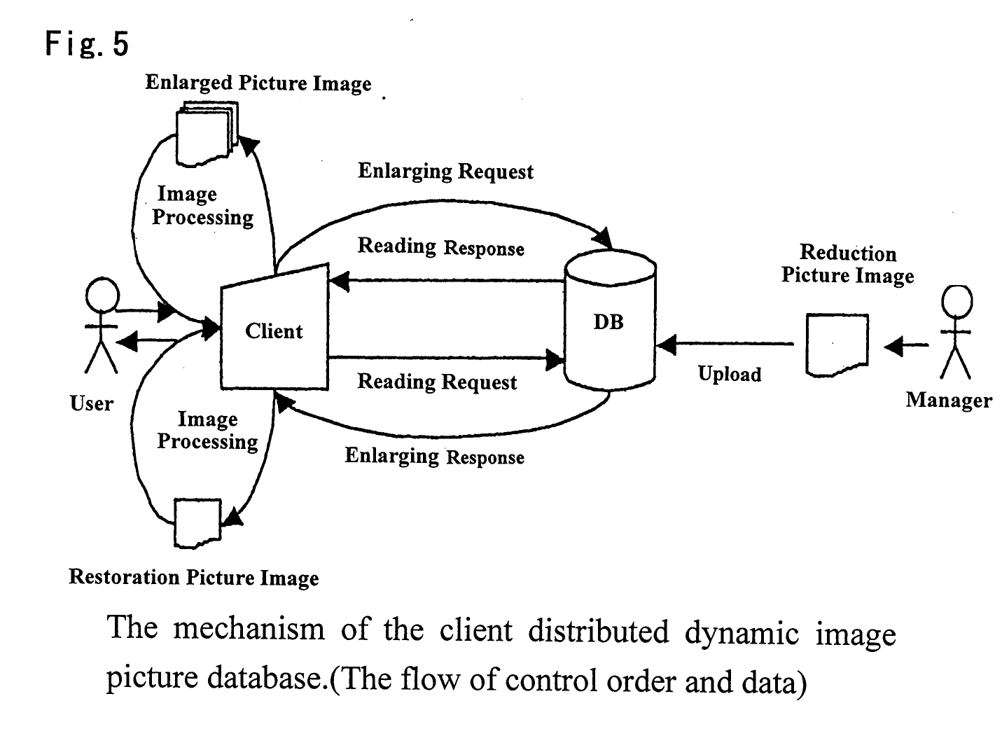

A series of actions are made into a diagram and shown in FIG. 5 in the viewpoint of a user and server manager, and the procedure will be explained.

The flow of operating procedure in this case is shown below. More specifically,
\mathring{1} A manager establishes a picture image database system; and in order to start service, a compressed picture image is uploaded by the manager as a base picture image.
\mathring{2} To a web site which has the picture image database system that has been established, a demand (request) for reading is issued through web browser in which the user is a client for the database system.
\mathring{3} The picture image database system which received the reading request from the client side analyzes the reading request and reports a response for reading (response) to the client side.
\mathring{4} The client restores the compressed picture image received from the picture image database system.
\mathring{5} If the user is satisfied with the restoration image information, the process ends at this point. If, however, the picture image information is insufficient to the content of the user, the user issues an enlarging (extension) request to the server.
\mathring{6} When the enlarging request from the user is received, the picture image database system retransmits the compressed picture image to the client.
\mathring{7} The client carries out picture image processing immediately and expands the picture image to the size which the user requests for.
\mathring{8} A picture image with an extension mapping is displayed for the user as a result of the response for extension in the client side who executes the picture image operation and processing as an extension mapping.

For each one of the examples of the system that has the function described above, details will be described below.

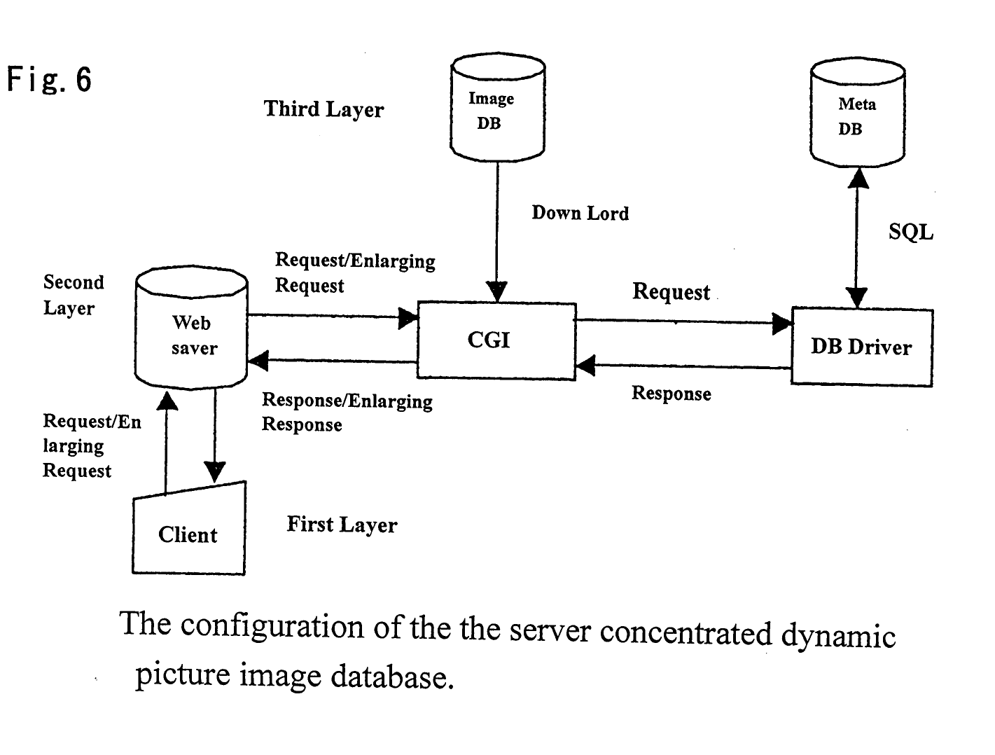

The server concentrated dynamic web picture image database system presented here is constructed in a three-layer structure in accordance with functions. The entire structure is shown in FIG. 6.

The first layer constitutes an existing general web browser, and it is provided as a client part. Here, the user makes a request for the database and receives responses.

The second layer is comprised of three parts including: a web server that has a role to receive a request from the first layer and returns a response to the first layer, a CGI technology that executes compression and restoration of a picture image and takes synchronization with each database on the server side, and a web database driver that fulfills an interface function for the meta database (which is a database in which a structure and storage location of picture images are inputted) thus making an operation from the web possible. These three parts are the core of the system.

The third layer is comprised of a meta database server, which responds a metadata of a picture images that is suitable for the conditions corresponding to the request from the second layer, and a picture image database, which responds the picture image datum to the web server by a request from the web server who received the metadata.

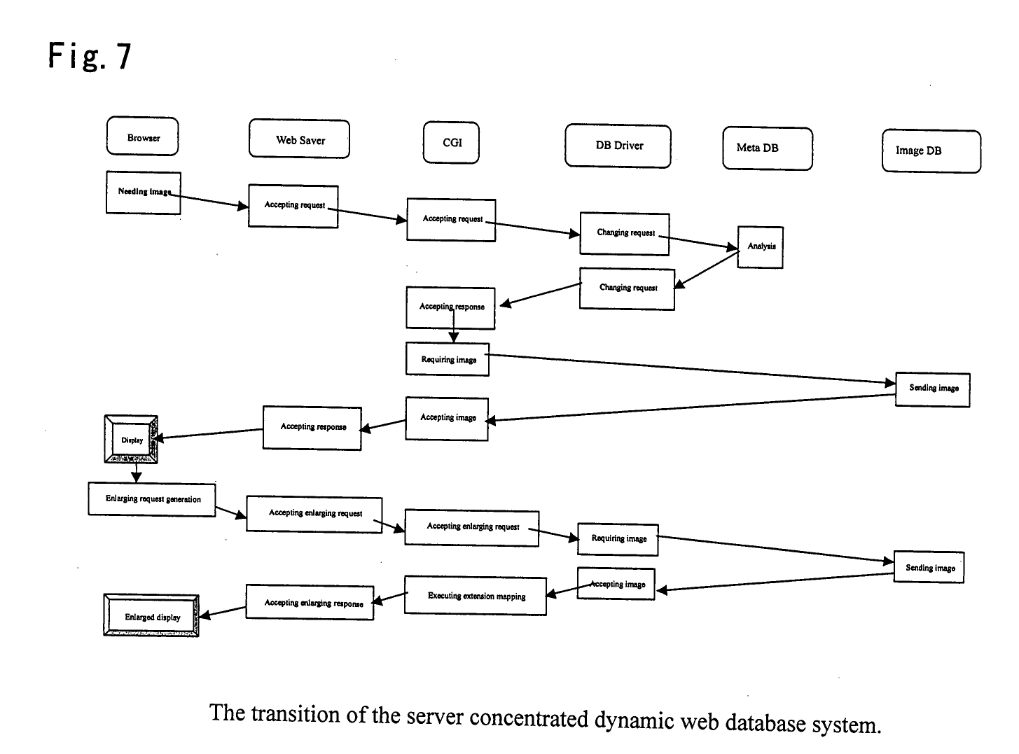

FIG. 7 shows, in the form of a state transition diagram, the procedure in which a client in the server concentrated dynamic web picture image database system receives a demanded picture image, wherein the object names are arranged laterally and the time is arranged longitudinally.

Steps for obtaining a demanded picture image in the server concentrated dynamic web picture image database.
\mathring{1} From a web browser, which is a client, a retrieval request by the user is issued to a web server.
\mathring{2} The web server transfers the retrieval request, which the client asked for, to a CGI that has a database system and a picture image processing mechanism.
\mathring{3} CGI provides an order, which contains the retrieval request from the client, to a database driver.
\mathring{4} The database driver rewrites the order into a format that is suitable for the meta database so that the retrieval request can be transmitted to the meta database, and the database driver provides the rewritten order to the meta database.
\mathring{5} After receiving the retrieval request, the meta database provides a retrieval response, which corresponds to the request, to the database driver.
\mathring{6} The database driver receives and rewrites the retrieval response for CGI use and provides it to CGI.
\mathring{7} CGI, upon receipt of the retrieval response, starts analysis, and it downloads the compressed picture image from the picture image database on the web.
\mathring{8} CGI respond to the web server with the retrieval response and picture image response.
\mathring{9} The web server, when the response group is received from CGI, makes, in accordance with the order of CGI, the compressed picture image information so as to be shown on a browser, and then a response is made to the client.
\mathring{10} When the user dissatisfies the size of the received picture image, a enlarging (extension) request on this picture image is created for the client.
\mathring{11} The web server provides the enlarging request to CGI when the enlarging request is received from the client.
\mathring{12} When the enlarging request is received, CGI downloads the picture image from the picture image database, carries out an extension mapping based on the requested magnification, and executes a wavelet transform.
\mathring{13} CGI responds to the web server with the result.
\mathring{14} The web server makes the result into a format that can be shown on a browser and responds to the client with a final picture image information.

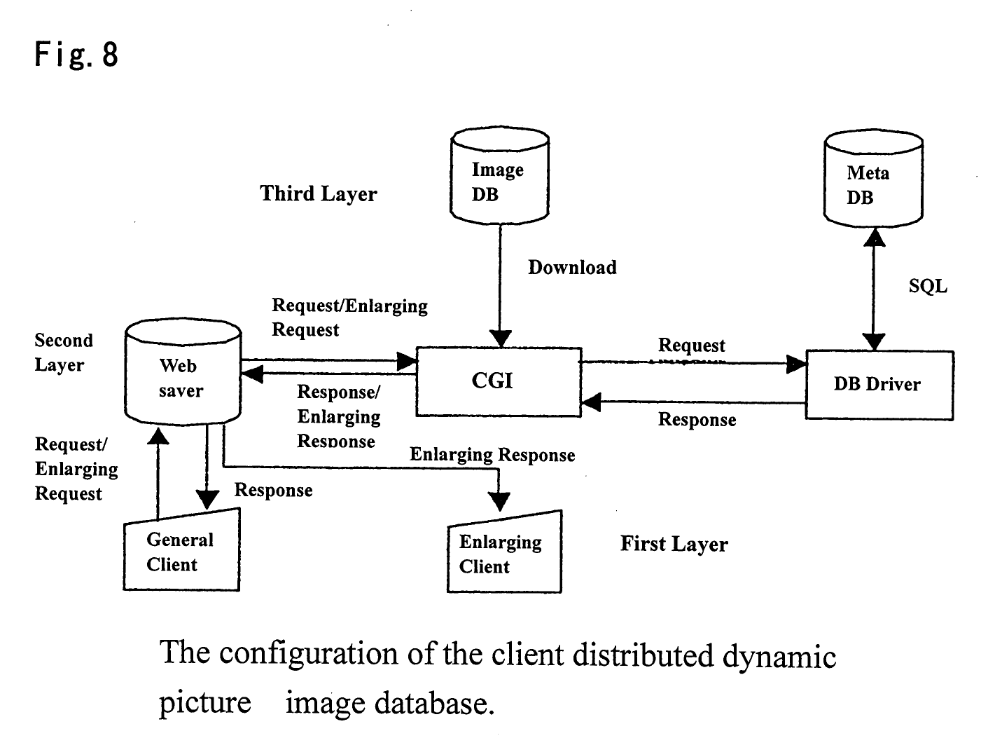

The client distributed dynamic web database system is also formed in a three-layer structure that has different functions. The entire construction in this case is shown in FIG. 8.

In the first layer, an exclusive-use application, which is in a form of an existing general web browser and picture image viewer (viewing program), is considered as a client part. Here, the user makes a request for the database and receives responses; and it is possible to receive a response for extension via a viewer.

The second layer is comprised of: a web server that undertakes the role to receive a request from the first layer and returns a response to the first layer, a CGI technology that executes compression and restoration of a picture image and takes synchronization with each database on the server side, and a web database driver that fulfills an interface function for the metadata base (which is a database in which a structure and storage location of picture images are inputted), thus making an operation from the web possible. The second layer is the core of the system.

The third layer is comprised of: a meta database server, which send to the second layer a response of a metadata of a picture image that is suitable for the conditions corresponding to the request from the second layer, and a picture image database, which send a response of the picture image datum to the web server by a request from the web server who received the metadata.

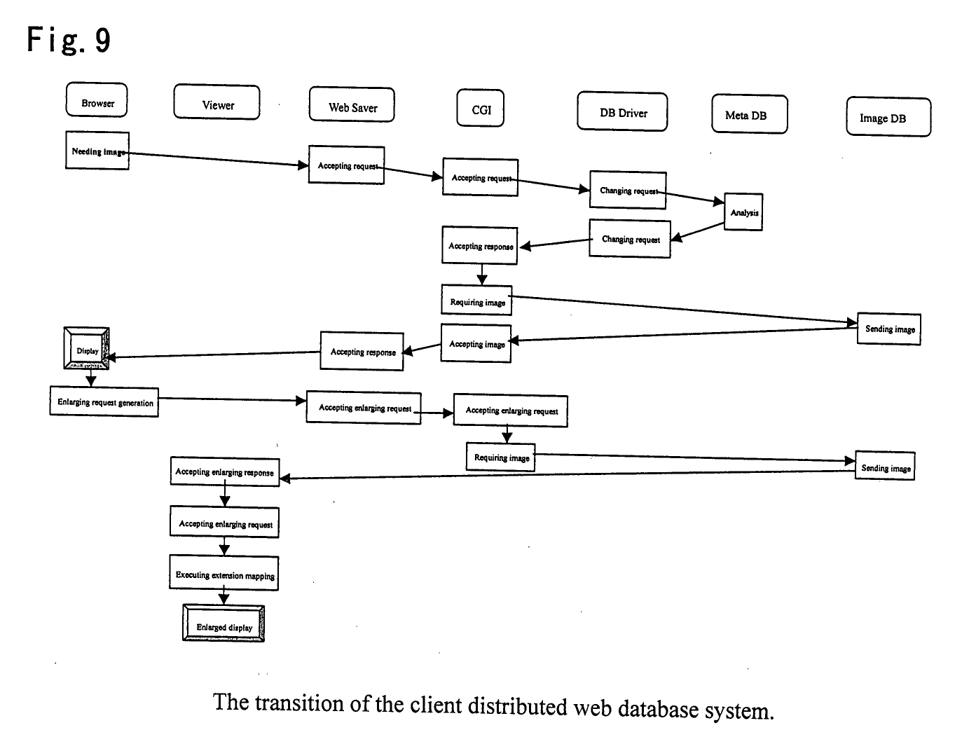

Next, the procedure in which a client of the client distributed web picture image database system receives a demanded picture image will be described with reference to FIG. 9 in the form of a state transition diagram, wherein the object names are arranged laterally and the time is arranged longitudinally.

Steps for obtaining a demanded picture image in the client distributed dynamic web picture image database.
\mathring{1} Through web browser, which is a client, a retrieval request is generated, as an operation result by the user, to the web server.
\mathring{2} The web server provides the retrieval request, which the client requested, to CGI that has a database system and picture image processing mechanism.
\mathring{3} CGI provides the order, which contains a retrieval request from the client, to the database driver.
\mathring{4} The database driver rewrites the order into a format that is suitable for the meta database so that the retrieval request can be transmitted to the meta database, and the database driver provides the rewritten order to the meta database.
\mathring{5} After receiving the retrieval request, the meta database provides a retrieval response that corresponds to the demand to the database driver.
\mathring{6} The database driver rewrites the retrieval response for CGI use upon receiving the retrieval response and provides it to CGI.
\mathring{7} CGI starts analysis when the retrieval response is received, and it downloads a compressed picture image from the picture image database on the web.
\mathring{8} CGI sends a retrieval response and compressed picture image response to the web server.
\mathring{9} The web server, when the response group from CGI is received, makes, in accordance with the order of CGI, a compressed picture image information to be shown on a browser and responds to the client with the information.
\mathring{10} a When the size of the requested picture image is dissatisfactory to the user, an enlarging (extension) request for the object picture image from the client is generated.
\mathring{11} When the enlarging request is received from the client, the web server provides the enlarging request to CGI.
\mathring{12} When the reading request is received, CGI downloads the compressed picture image from the picture image database and provides it to the web server as a response for extension.
\mathring{13} The web server executes, in an exclusive-use application for a viewer, a response for extension on the compressed picture image that is responsive to the response for extension.
\mathring{14} Upon receipt of the response for extension, based on the wavelet system, the exclusive-use application for a viewer decompresses the compressed picture image and displays it in the viewer.

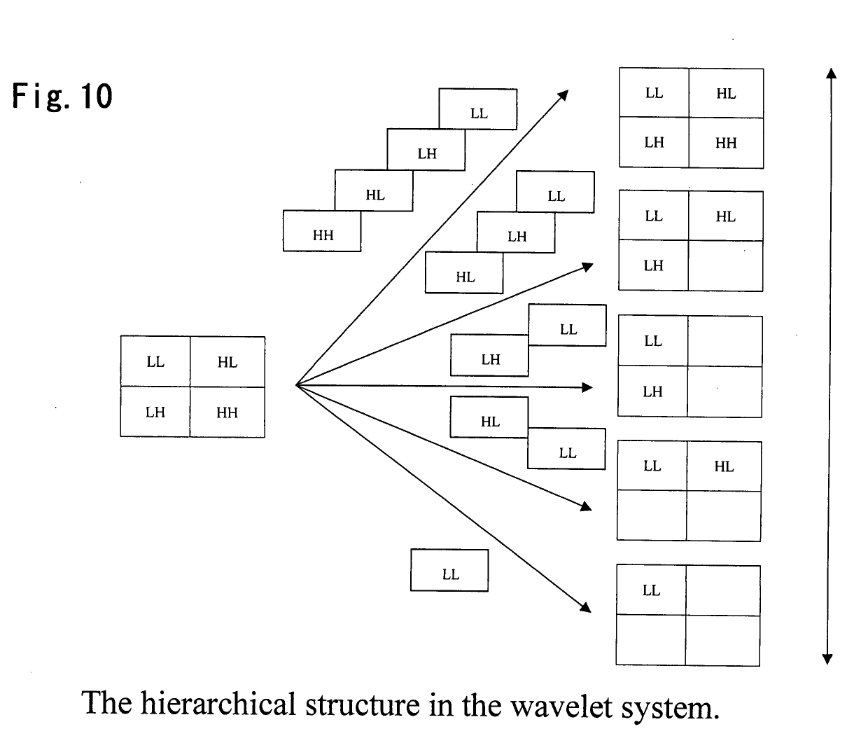

The integrated picture image processing mechanism, which is a core of the dynamic picture image database and fulfills the role of basic technology, will be described. Here, the hierarchy of the wavelet method, which is a core of the dynamic picture image database, namely the hierarchical structure, is shown in FIG. 10. In this case, it can be freely done that a picture image quality is adjusted by linking other component by way of making LL component to be the basic structure in the restoration process.

The extension mapping that uses the wavelet transform which is the basic function of the picture image processing mechanism of the dynamic picture image database system, as described above, keeps the frequency structure of a picture image, which is specified in the dissociation process that is a reduction mapping, in the extension mapping; and it is a picture image processing method (that is called hereinafter a “wavelet transform based on extension mapping”) that is used recursively as an algorithm. What is constructed on the basis of wavelet transform based on such extension mapping is a core of the picture image processing mechanism.

The structural content of the above-described method can be described as a next conversion.

The picture image upon which the wavelet transform is executed is decomposed into components LL, LH, HL and HH.

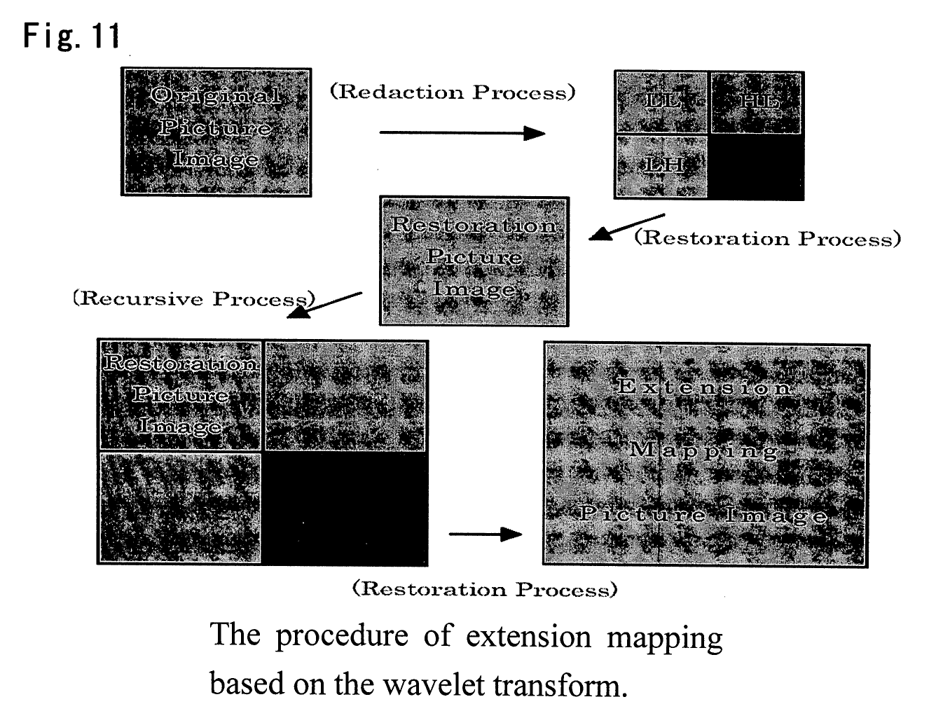

Within the above, in a part in which the value of the concentration of the frequency component is high, the high component of shape and color consistency of the picture image is included in the frequency component LL. Though the wavelet transform can be restored in LL component only as described above, the resultant is a low quality picture image; thus an original picture image is condensed as level 1 of the wavelet transform, and then it is restored in level 1. Afterwards, it is placed, after preparation of a picture image space of double size, as an LL component in the picture image space. However, the space except the LL space is compulsorily made to be 0. In addition, the picture image processing can be constituted as a picture image which is equivalent to level 1 as wavelet conversion only by the LL component based on the method for synthesizing double picture image space in level 1 of wavelet transform. The scale of the restoration picture image here is a double size of the original picture image. Clearly, though the picture image structure determined as a resolution process is naturally preserved in the restoration process, a recursive structure relation is considered in the extension process. That is to say, the method of extension mapping which can be defined as a recursive restoration treatment is the picture image processing method. This recursive procedure and process are shown in FIG. 11.

1. A method which is comprised of, as a core structure for a unitary treatment of an integrated picture image processing mechanism, the steps of:
forming a frequency structure in a dissociation process that is a reduction mapping of wavelet transform, and
executing wavelet extension mapping in which said frequency structure is recursively used in an extension operation, said frequency structure being preserved.

2. A method which is an upper level mechanism related to the method of claim 1, wherein said method is comprised of the steps of:
combining a picture image processing, which is based on wavelet transform, with a wavelet extension mapping,
executing thereby a unitary processing, and
forming an integration-oriented picture image processing mechanism that has a mechanism which realizes integrated management and control.

3. A method which is an upper level mechanism related to the method of claim 2, wherein said method is comprised of, in constructing database support and management system of picture image database, the steps of:
incorporating an integrated picture image processing mechanism,
realizing metafile as a retrieval system and utilizing a picture image attribute, and
managing and controlling picture image database thereby.

4. A method which is a system related to the method of claim 3, wherein said method is comprised of, in constructing dynamic picture image database which can realize web-oriented picture image database, the steps of:
forming a system that satisfies a client's demand of picture image size and picture image quality by, in addition to a processing function of web server, a function of integrated picture image processing mechanism; and
constructing and utilizing server concentrated dynamic picture image database on which a concentrated management is performed.

5. A method which is a system related to the method of claim 3, wherein said method is comprised of, in constructing dynamic picture image database which can realize web-oriented picture image database, the steps of:
forming a system in which a client satisfies himself with a demand of picture image size and picture image quality in a self reference style, said client adding and integrating, as a client's function, a function of integrated picture image processing mechanism in addition to a processing function of web server; and
constructing client distributed dynamic picture image database on which a dispersive management is performed.

6. A medium, which is recorded with a picture image processing program, characterized in that said program, as a core structure of a unitary processing for integrated picture image processing mechanism:
forms a frequency structure in a dissociation process which is a reduction mapping of wavelet transform, and
executes wavelet extension mapping which recursively uses said frequency structure in an extension operation, said frequency structure being preserved; and
whereby said program allows a computer to function for wavelet extension mapping.

7. A medium, which is recorded with a picture image processing program based mainly on a wavelet extension mapping, characterized in that said program:
combines a picture image processing based on wavelet transform with wavelet extension mapping,
executes thereby a unitary processing, and
forms an integration-oriented picture image processing mechanism that has a mechanism which realizes integrated management and control;
wherein said program allows a computer to function as an integration-oriented picture image processing mechanism.

8. A medium, which is recorded with a management and control program, characterized in that said program, in constructing database support and management system of picture image database:
incorporates an integrated picture image processing mechanism,
realizes a metafile as a retrieval system and utilizes a picture image attribute, and
manages and controls picture image database thereby; and
wherein said program allows a computer to fumction to manage and control the picture image database.

9. A medium, which is recorded with a program that drives server concentrated dynamic picture image database, characterized in that said program, in constructing dynamic picture image database which can realize web-oriented picture image database:
forms a system that satisfies a client's demand of picture image size and picture quality by, in addition to a processing function of web server, a function of integrated picture image processing, and
forms server concentrated dynamic picture image database on which a concentrated management is performed; and
wherein said program allows a computer to function as a server concentrated dynamic picture image database.

10. A medium, which is recorded with a program that drives client distributed dynamic picture image database, characterized in that said program, in constructing dynamic picture image database which can realize a web-oriented picture image database:
forms a system in which a client satisfies himself with a demand of picture image size and picture image quality in a self reference style, said client adding and integrating, as a client's function, a function of integrated picture image processing mechanism in addition to a processing function of web server, and
forms client distributed dynamic picture image database on which a dispersive management is performed; and
wherein said program allows a computer to function-as a client distributed dynamic picture image database.
